(19) United States
(12) Patent Application Publication
(10) Pub. No.: US 2026/0070236 A1
(43) Pub. Date: Mar. 12, 2026

(54) END-OF-ARM TOOL ASSEMBLY FOR A ROBOTIC MANIPULATOR

(71) Applicant: Ocado Innovation Limited, Hatfield (GB)

(72) Inventors: Paris THOMAS, Welwyn (GB); Enrique DEL SOL ACERO, London (GB); Josue CAMACHO, Hitchin (GB); Jan FRAS, Kornik (PL); Krishna Vivek SAMAYAMANTRI, Shepperton (GB); Alexandre Paschoal VICENTE, London (GB)

(21) Appl. No.: 19/106,345

(22) PCT Filed: Aug. 25, 2023
(86) PCT No.: PCT/EP2023/073421

§ 371 Date: Feb. 25, 2025

(30) Foreign Application Priority Data
Aug. 26, 2022 (GB) 2212427.5

(51) Int. Cl. B25J 15/08

(52) U.S. Cl. CPC B25J 15/08

(57) ABSTRACT

An end-of-arm tool assembly (16) for a robotic arm, the tool assembly comprising a housing (102) and an actuator (102) comprising two counter-moving components (104). The actuator is mounted within the housing such that both counter-moving components are movable. The tool assembly further comprises a linkage assembly (114) comprising two linkage subassemblies (116a, 116b). Each linkage sub-assembly connects the actuator to a finger assembly (120, 122). The actuator and link-age assembly are configured such that one of the linkage subassemblies is driven by one of the counter-moving components and the other of the linkage subassemblies is driven by the other of the counter-moving components.

The present disclosure relates to an end-of-arm tool or gripper assembly for a robotic manipulator. Aspects of the invention relate to the end-of-arm tool assembly and to the robotic manipulator comprising the tool assembly.

### BACKGROUND

Known end-of-arm tool assemblies operate with indirect force control schemes using either a position control scheme, or a force plus position control scheme. In the position control scheme, the respective positions of the tool's finger assemblies are controlled independently of the gripping force applied at the finger assemblies. In the force plus position control scheme, the respective positions of the finger assemblies are controlled with respect to a force limit. That is, force plus position control schemes do not maintain or adjust the gripping force, but simply limit the maximum force that can be applied at the finger assemblies. The problem with these indirect force control schemes is that they need extra force sensors at the contact areas of the finger assemblies in order to measure gripping force. Also, since the force control is done indirectly through position, even if there is a feedback of the gripping force, the control is prone to instability due to contact modelling errors. Also, most of the tool assemblies in the market are not backdrivable, making them less safe to interact with. Such control schemes are also a source of instability and poor control performance.

### It Is Against This Background That the Invention Was Devised.

### SUMMARY

Accordingly, there is provided, in one aspect, an end-of-arm tool or gripper assembly for a robotic arm, the tool assembly comprising a housing, an actuator comprising two counter-moving components, the actuator being movably mounted within the housing such that both counter-moving components are movable and a linkage assembly comprising two linkage subassemblies, each linkage subassembly being arranged to connect the actuator to a finger assembly, wherein the actuator and the linkage assembly are configured such that one of the linkage subassemblies is driven by one of the counter-moving components and the other of the linkage subassemblies is driven by the other of the counter-moving components.

This arrangement is advantageous, firstly, in that it enables the end-of-arm tool assembly to be controlled using a direct force control scheme as opposed to using a position control scheme. When using position control schemes, target positions for finger assemblies are determined based on an item to be manipulated or grasped and the force applied to the item is a function of the target positions. Such control schemes are appropriate for applications in which the items to be manipulated have generally similar or the same characteristics. In other applications, however, such as an online grocery retail operation, having 1,000s or 10,000s of items of varying characteristics (e.g., shape, size, weight, rigidity, coefficient of friction, etc.,), such control schemes are inappropriate as two items of similar sizes might be very different in other respects, and so the force applied to them by the finger assemblies, determined as a function of their respective positions, might be unsuitable. That is, in most instances, the relationship between the applied force and position of the finger assemblies is unknown when using position control schemes. With the present arrangement, however, which lends itself to a direct force control scheme, target positions or any feedback regarding the positions of the finger assemblies is not required. Instead, the output force or torque of the actuator is controlled to match the desired force applied by finger assemblies to the item being manipulated. This is made possible by the novel arrangement of using a direct connection between the linkage assembly and actuator. The linkage assembly is a low friction transmission device or arrangement, which, in this instance, is used to convert output force of the actuator to axially reciprocating movement of the finger assemblies. Because of the relatively low friction of the transmission device, and in the absence of other transmission mechanisms, such as a gearing arrangement between the actuator and the linkage assembly, the applied force of the finger assemblies is proportional to the force output of the actuator, meaning that the applied force can be accurately mapped with respect to the force outputted by the actuator to provide precise direct force control capability without the need for external force measurement.

Secondly, because the linkage assembly provides a low friction transmission between the actuator and finger assemblies, the end-of-arm tool assembly is mechanically backdrivable. That is, the finger assemblies can be moved manually, towards or away from each other, to effect movement of the linkage assembly and actuator. This ensures that the end-of-arm tool assembly has a degree of compliance, permitting safe physical interaction with its workspace.

Finally, the absence of an intermediate transmission device, such as a gearing arrangement, between the actuator and linkage assembly minimises the “backlash” within the assembly, which could otherwise lead errors in the force applied by the finger assemblies to an item being manipulated. The absence of an intermediate transmission device or arrangement also helps to keep the overall weight of the end-of-arm tool assembly to a minimum.

Optionally, the counter-moving components are counter-rotatable and wherein the actuator is rotatably mounted within the housing such that both counter-rotating components are rotatable.

In this instance, the actuator might be a motor, having a stator and rotor as the counter-rotating components. Conventionally, the stator would be secured to the housing, preventing its rotation relative to the rotor. The arrangement of the current end-of-arm tool assembly, however, allows both the rotor and what would normally be considered to be the stator to counter-rotate within the housing to produce equal but opposite torques. This means the output torque produced by the rotation of what would normally be considered to be the stator, instead of being absorbed by housing, as would be the case in a conventional arrangement where the stator is secured to the housing, can be used to drive one of the linkage subassemblies, while the output torque of the rotor is used to drive the other of the linkage subassemblies, thereby doubling the effective force applied to the linkage assembly without the use of an intermediate transmission device between the actuator and linkage assembly.

Optionally, the counter-rotating components are concentrically arranged about a common rotational axis.

Optionally, the end-of-arm tool assembly further comprises a coupler assembly connected to the linkage subassemblies. Optionally, the coupler assembly comprises an elongate guide rail and a slider coupling the linkage subassemblies, wherein the slider is configured to reciprocate along the guide rail as the actuator drives the linkage assembly. Optionally, a longitudinal or major axis of the guide rail is perpendicular to the common rotational axis.

Optionally, each linkage subassembly comprises an actuator linkage rotationally coupled to one of the counter-rotating components and pivotally connected to the other linkages of the linkage subassembly.

Optionally, the pivotal connections between the actuator linkage and the other linkages of the linkage subassembly are equidistant from the common rotational axis.

In another aspect, there is provided a robotic manipulator comprising an end-of-arm tool assembly according to the previous aspect.

### BRIEF DESCRIPTION OF THE DRAWINGS

These and other aspects of the invention will now be described, by way of example only, with reference to the accompanying drawing, in which:

FIG. 1 is a schematic view of a manipulator apparatus for use with the invention; according to an embodiment of the invention;

FIG. 2 is a cross-sectional plan view of an end-of-arm tool assembly according to an embodiment of the invention for use with the manipulator apparatus of FIG. 1, wherein the end-of-arm tool assembly is a closed configuration;

FIG. 3 is a cross-sectional plan view of the end-of-arm tool assembly of FIG. 2 in an open configuration; and,

FIG. 4 is a cross-sectional side view of the end-of-arm tool assembly of FIG. 2.

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.” Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

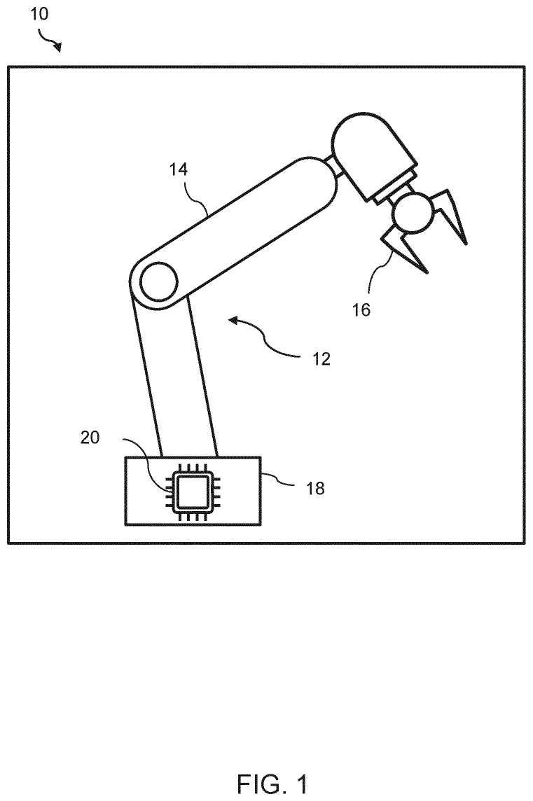

FIG. 1 shows an example manipulator apparatus, generally designated by 10. The manipulator apparatus 10 comprises a robotic manipulator 12 including a robotic arm 14, an end effector or end-of-arm tool assembly 16 (hereinafter, “tool assembly 16”) and a motion subsystem 18. The motion subsystem 18 is communicatively coupled to the robotic arm 14 and tool assembly 16, and is configured to cause the robotic arm 14 and tool assembly 16 to move in accordance with actuation commands or control signals issued by a controller 20, which forms part of the manipulator apparatus 10. The robotic arm 14 and tool assembly 16 define a plurality of interconnected parts that are configured to move relative to each other in order to carry out the manipulation of an object, e.g., grasped by the tool assembly 16. Motors and respective gearboxes are provided at junctions between the interconnected parts to enable the relative movement.

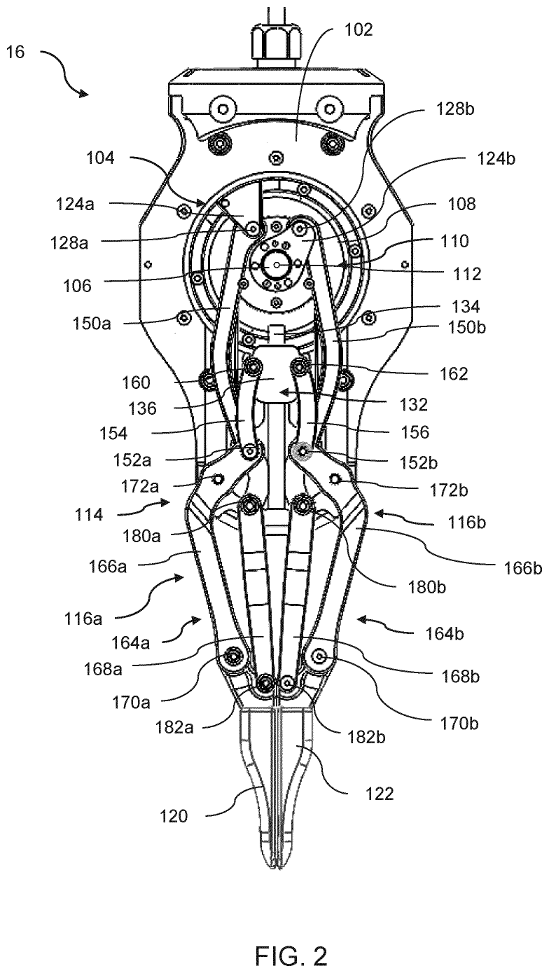

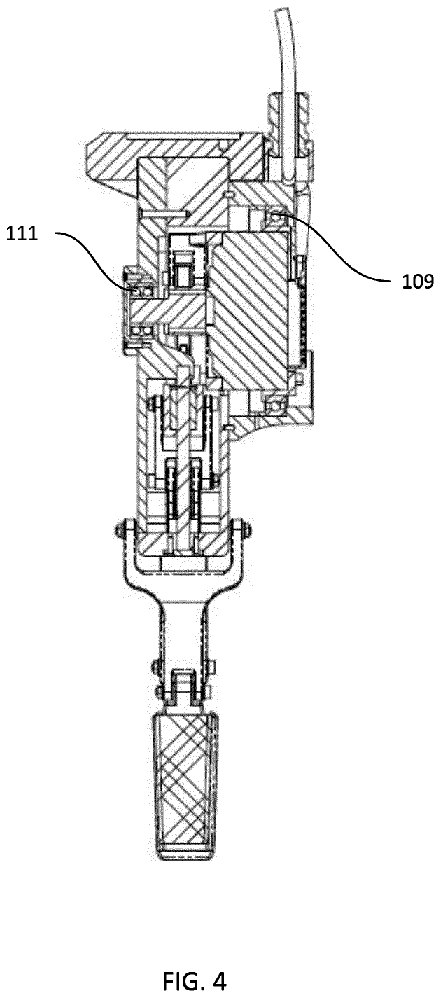

With reference to FIG. 2, the tool assembly 16 comprises a housing 102 and an actuator, generally designated by 104, comprising two counter-moving components 106, 108. The actuator 104 is mounted within the housing 102 such that both counter-moving components 106, 108 can move therein in an opposing manner. That is, the actuator 104 is mounted in the housing 102 so that one of the counter-moving components 106, 108 is able to move in a first direction, while the other of the counter-moving components 106, 108 is arranged to move in a second direction, the second direction being opposite to the first direction. In this example, the actuator 104 is a motor 110 comprising a rotor 106 and what would normally be considered to be a stator 108, jointly defining counter-rotating components concentrically arranged about a common rotational axis 112. Conventionally, the stator 108 would be secured to the housing 102, preventing its rotation relative to the rotor 106. In this example, however, the “stator” 108 is rotatably supported within the housing 102 on a first bearing assembly 109 (see FIG. 4), enabling it to rotate within the housing 102 in one of a clockwise or anticlockwise direction. Similarly, a second bearing assembly 111 (see FIG. 4) rotatably supports the rotor 106 within the housing 102, allowing it to rotate in the other of a clockwise or anticlockwise direction.

The tool assembly 16 further comprises a linkage assembly, generally designated by 114, having two linkage subassemblies 116a, 116b operatively connecting the actuator 10 to respective finger assemblies 120, 122. That is, the linkage assembly 114 functions as a transmission device, converting the motion of the actuator into a reciprocating movement of the finger assemblies 120, 122. In the given example, one of the linkage subassemblies 116a, 116b is driven by one of the counter-moving components 106, 108 and the other of the linkage subassemblies 116a, 116b is driven by the other of the counter-moving components 106, 108. Each of the linkage subassemblies 116a, 116b includes an actuator linkage 124a, 124b, providing a direct connection between respective linkage subassemblies 116a, 116b and counter-moving components 106, 108. To that end, each actuator linkage 124a, 124b is fixedly coupled to one of the counter-moving components 106, 108, preventing relative movement therebetween, and pivotally connected to the other linkages of their respective linkage subassembly 116a, 116b. In the example shown, linkage subassembly 116a is connected to one of the counter-moving components 108 (i.e. the “stator” 108) by actuator linkage 124a, which is configured to pivot with respect to the other linkages of linkage subassembly 116a about a joint pin 128a. Similarly, linkage subassembly 116b connects to the other of the counter-moving components 106 (i.e. the rotor 106) by actuator linkage 124b, which is configured to pivot with respect to the other linkages of linkage subassembly 116b about another joint pin 128b.

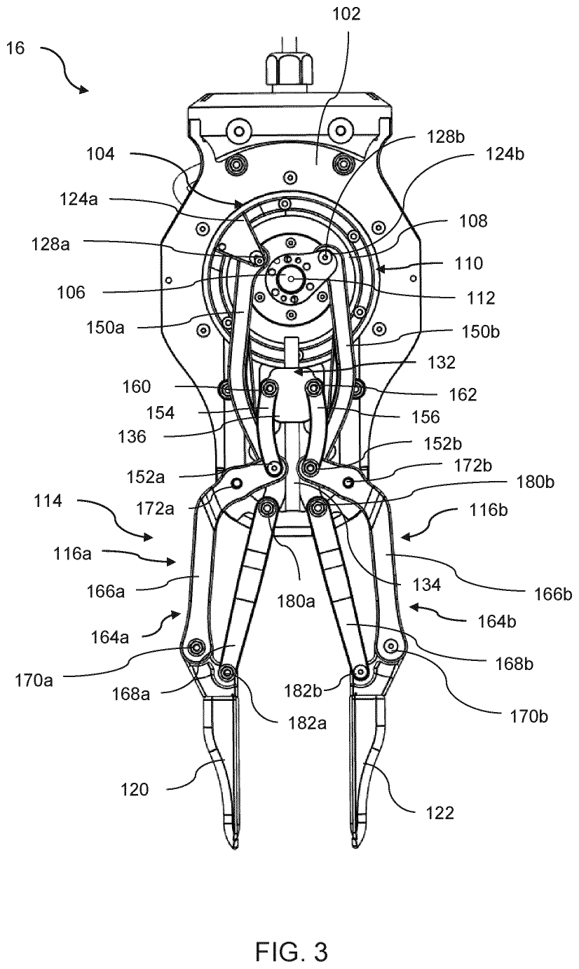

In order to facilitate complementary movement of the linkage subassemblies 116a, 116b, and so the finger assemblies 120, 122, between a closed configuration, as shown in FIG. 2, and an open configuration, as shown in FIG. 3, the actuator linkages 124a, 124b are arranged such their respective pivotal connections, defined by joint pins 128a, 128b, are substantially the same distance from the rotational axis 112 regardless of the positions of the counter-moving components 106, 108.

In addition to the actuator linkages 124a, 124b, each linkage subassembly 116a, 116b further comprises a connection rod 150a, 150b rotatably mounted, at its upper end, between one of the joint pins 128a, 128b and, at its lower end, one of joint pins 152a, 152b.

The tool assembly 16 further comprises a coupler assembly 132, providing an interconnection between linkage subassemblies 116, 118. This interconnection establishes a coupled association between the linkage subassemblies 116, 118, ensuring a corresponding movement of the finger assemblies 120, 122. The coupler assembly 132 comprises an elongate guide rail 134, arranged such that its major axis extends perpendicular with respect to the common rotational axis 112, and a slider 136 connected to the linkage subassemblies 116, 118. The slider 136 is configured to reciprocate along the guide rail 134 as the actuator 104 drives the linkage assembly 114 between the open and closed configurations. The coupler assembly 132 further comprises two connector arms 154, 156 connecting the slider 136 to the linkage assemblies 116a, 116b and ensuring a coupled movement between the slider 136 and linkage assembly 114. Each connector arm 154, 156 is rotatably mounted on the slider 136 by one of joint pins 160, 162 and rotatably connected to the linkage subassemblies 116a, 116b by the joint pins 152a, 152b.

The joint pins 152a, 152b also function as pivotal connections between the connection rods 150a, 150b and respective crank linkages 164a, 164b, which also form part of the linkage subassemblies 116a, 116b. The crank linkages 164a, 164b provide a movable connection between the finger assemblies 120, 122 and the other components of each of the linkage subassemblies 116a, 116b, and each comprise an outer crank arm 166a, 166b and an inner crank arm 168a, 168b. One end of each of the outer crank arms 166a, 166b is rotatably connected to one of the connection rods 150a, 150b by one of the joint pins 152a, 152b, and the other end of each of the outer crank arms 166a, 166b is rotatably connected to one of the finger assemblies 120, 122 by one of joint pins 170a, 170b. Each of the outer crank arms 166a, 166b is pivotally mounted on the housing 102 by respective joint pins 172a, 172b, and it is about these joint pins 172a, 172b that the outer crank arms 166a, 116b rotate, under the displacement of the connection rods 150a, 150b by the actuator 104, to effect movement of the finger assemblies 120, 122 between the open and closed configurations. As mentioned above, the crank linkages 164a, 164b further comprise one of the inner crank arms 168a, 168b. One end of each of the inner crank arms 168a, 168b is rotatably mounted to the housing 102 by joint pins 180a, 180b and the other end of each of the arms 168a, 168b in movably connected to one of the finger assemblies 120, 122 by one of joint pins 182a, 182b. The inner crank arms 168a, 168b are passive components of the linkage assembly 114 and function to ensure that the orientation of the finger elements 120, 122 remains constant throughout their movement between the open and closed configurations.

In the present arrangement, the linkage assembly 114 functions as a direct transmission arrangement, converting the movement of the actuator 104 into reciprocating movement of the finger assemblies 120, 122, without the need for intermediate transmission mechanisms, such as a gearing arrangement. The applied force of the finger assemblies therefore is directly proportional to the force output of the actuator, meaning that the applied force can be accurately mapped with respect to the force outputted by the actuator to provide precise direct force control capability without the need for external force measurement. Also, the absence of any geared transmission means that the tool assembly 16 has minimal backlash and is backdriveable, further improving the accuracy by which it can be controlled.

The above example is to be understood as illustrative. Further examples are envisaged. For instance, the specific arrangement of the linkage assembly 114, other than its direct connection to the counter-moving components 106, 108 of the actuator 104, may be changed, as can the arrangement for coupling the movement of the linkage subassemblies 116a, 116b.

1. An end-of-arm tool assembly for a robotic arm, the tool assembly comprising:
a housing;
an actuator comprising two counter-moving components, the actuator being mounted within the housing such that both counter-moving components are movable; and,
a linkage assembly comprising two linkage subassemblies, each linkage subassembly being arranged to connect the actuator to a finger assembly, wherein the actuator and the linkage assembly are configured such that one of the linkage subassemblies is driven by one of the counter-moving components and the other of the linkage subassemblies is driven by the other of the counter-moving components.

2. The end-of-arm tool assembly according to claim 1, wherein the counter-moving components are counter-rotatable and wherein the actuator is rotatably mounted within the housing such that both counter-rotating components are rotatable.

3. The end-of-arm tool assembly according to claim 2, wherein the counter-rotating components are concentrically arranged about a common rotational axis.

4. The end-of-arm tool assembly according to claim 2, further comprising a coupler assembly connected to the linkage subassemblies.

5. The end-of-arm tool assembly according to claim 4, wherein the coupler assembly comprises a guide rail and a slider coupling the linkage subassemblies, wherein the slider is configured to reciprocate along the guide rail as the actuator drives the linkage assembly.

6. The end-of-arm tool assembly according to claim 5, wherein the counter-rotating components are concentrically arranged about a common rotational axis, and a longitudinal axis of the guide rail is perpendicular to the common rotational axis.

7. The end-of-arm tool assembly according to claim 1, wherein the counter-moving components are counter-rotatable and each linkage subassembly comprises an actuator linkage rotationally coupled to one of the counter-rotating components and pivotally connected to the other linkages of the linkage subassembly.

8. The end-of-arm tool assembly according to claim 7, wherein the counter-rotating components are concentrically arranged about a common rotational axis, and the pivotal connections between the actuator linkage and the other linkages of the linkage subassembly are equidistant from the common rotational axis.

9. A The end-of-arm tool assembly according to claim 1, wherein the actuator comprises a motor.

10. A robotic manipulator comprising a tool assembly the tool assembly comprising:
a housing;
an actuator comprising two counter-moving components, the actuator being mounted within the housing such that both counter-moving components are movable; and,
a linkage assembly comprising two linkage subassemblies, each linkage subassembly being arranged to connect the actuator to a finger assembly, wherein the actuator and the linkage assembly are configured such that one of the linkage subassemblies is driven by one of the counter-moving components and the other of the linkage subassemblies is driven by the other of the counter-moving components.
